(19) United States
(12) Patent Application Publication
(10) Pub. No.: US 2013/0098403 A1
(43) Pub. Date: Apr. 25, 2013

(54) VEHICLE WASH STATION

(71) Applicant: Prefix Corporation, Rochester Hills, MI (US)

(72) Inventors: Kim Zeile, Clarkston, MI (US); Kurt Zeile, Lake Orion, MI (US); Reks F. Alto, Warren, MI (US); John E. Campbell, Hazel Park, MI (US)

(73) Assignee: PREFIX CORPORATION, Rochester Hills, MI (US)

(21) Appl. No.: 13/655,989

(22) Filed: Oct. 19, 2012

Related U.S. Application Data
(60) Provisional application No. 61/549,313, filed on Oct. 20, 2011.

(51) Int. Cl. B08B 3/04

(52) U.S. Cl. 134/18; 134/105; 134/34

(57) ABSTRACT

A method and apparatus for washing a vehicle or water craft includes heating only a quantity of clean wash fluid required to completely wash the exterior of the watercraft to a first predetermined temperature. The heated clean wash fluid is discharged through one or more nozzles on a wash station platform at a predetermined temperature so that the temperature of the wash fluid as it strikes the hull of the water craft is at a second minimum temperature to kill organisms adhered to the vehicle. The clean wash fluid is applied in a number of successive wash cycles each covering a predetermined section of the exterior of the watercraft over a predetermined discharge time period for each section. Rotary spinning, oscillating, fixed and manually moveable nozzles are mounted on the wash station platform to automatically and manually provide wash fluid over the entire exterior surface of the water craft.

### CROSS REFERENCE TO CO-PENDING APPLICATION

This application claims priority benefit to the filing date of Oct. 20, 2011 filing date of co-pending U.S. Provisional Patent Application Ser. No. 61/549,313, filed in the name of Kim Ziele, et. al. for a Vehicle Wash Station, the entire contents of which are incorporated herein by reference.

### BACKGROUND

This description relates to vehicle wash stations and, more particularly, to mobile vehicle wash stations.

One factor in maintaining a clean environment is to maintain water, such as lakes, rivers, etc. free of undesirable aquatic plants, animals, fish, or water related material.

Despite precautions, bodies of water have become contaminated with undesirable animals, larvae, eggs, or plants. Since marine vessels are frequently moved between bodies of water, one form of spread of contamination is the transfer of a marine vessel, such as a boat and/or its trailer, from one contaminated body of water to another. Minute plants, animals, fish, and debris, such as mud containing such plants, animals, etc. adhere to the marine vessel or trailer. To prevent the transfer of undesirable aquatic life from a contaminated body of water to a non-contaminated body of water, it is necessary that any portion of a marine vessel that came into contact with the contaminated water be rinsed clean of such water and any water carried contaminants.

While hoses can be used at lake launches or entry ramps, the water is typically at ambient temperature as it was drawn from the body of water. Further, it is difficult to completely rinse all underside portions of the trailer and vessel, while standing on one side or the other of the trailer.

Thus, what is needed is a wash apparatus which can be employed at water access sites and, particularly, at boat launch ramps on bodies of water to assure that any contaminants from the body of water are rinsed free of the marine vessel and its trailer.

It would also be desirable to provide a wash station which can be used to wash equipment or vehicles at construction, land-management, environmental, agriculture, as well as nautical sites. In addition to cleaning such equipment or vehicles by removing dirt and other debris picked up at the site, it would also be desirable to provide a means for minimizing the transfer of toxins, fertilizers or other biological or chemical components from one site to another as the equipment and vehicles are moved from site to site.

### SUMMARY

A method of washing a vehicle includes the steps of determining an amount of clean wash fluid to wash the complete exterior of the vehicle, and heating only the determined amount of clean wash fluid to wash the complete exterior of the vehicle to a first predetermined temperature so that the temperature of the clean wash fluid discharged from at least one nozzle onto the vehicle is at a second predetermined temperature.

The determined amount of clean wash fluid is heated to a first predetermined temperature so that the temperature of the clean wash fluid discharged from at least one nozzle onto the vehicle is at a second predetermined temperature.

The method of further includes providing the overall length of the vehicle to be washed, providing a quantity of clean wash fluid in a first tank sufficient to completely wash an exterior of the predetermined length of the vehicle.

The method further includes providing a waste water fluid collection reservoir, providing a filter disposed in fluid flow communication with the waste water collection reservoir for filtering the dirty wash fluid of contaminants to create clean wash fluid, and disposing a clean wash fluid reservoir in fluid flow communication between the filter and the first tank.

The method further provides disposing a refill tank disposed in fluid flow communication between the clean wash fluid reservoir and the first tank, and providing fluid flow means for transferring clean wash fluid from the clean wash fluid reservoir to the refill tank.

The method further includes defining a plurality of consecutive wash cycles, each of a predetermined time period, each corresponding to a portion of the determined length of the washed vehicle discharging clean wash fluid at the second predetermined temperature during each of the plurality of wash cycles, and advancing the vehicle through the wash station with respect to the plurality of nozzles between the each wash cycle.

A wash apparatus includes at least one nozzle mounted on a platform for oscillatory movement to spray clean wash fluid over a predetermined bandwidth of the vehicle.

The wash apparatus includes a plurality of nozzles mounted on the platform for oscillatory movement about a common axis. The wash apparatus heated a quantity of clean wash fluid to a first predetermined temperature so that the temperature of the clean wash fluid discharged from the nozzles onto the vehicle is at a second predetermined temperature when it strikes the vehicle.

The wash apparatus includes the at least one or more nozzles mounted on the platform for rotary spinning movement to spray clean wash fluid over a predetermined bandwidth portion of the vehicle.

A wash apparatus includes a platform with opposed ends, the platform supporting a vehicle during a wash operation as the vehicle advances from end to end on the platform, a plurality of discrete, stationary, spaced vehicle positions on the platform, each discrete vehicle position defining a discrete wash cycle position, and at least one nozzle configured for discharging clean wash fluid onto successive bandwidth sections of the vehicle defined by a successive and stop advance of the vehicle between each discrete stationary vehicle position on the platform.

The wash apparatus includes a plurality discrete position sensors carried on the platform, each sensor defining one of the plurality of discrete spaced stationary vehicle positions on the platform for a discrete wash cycle application of clean wash fluid onto the vehicle.

The wash station, during each bandwidth application of clean wash fluid onto the vehicle, uses at least one nozzle to discharge clean wash fluid so that the clean wash fluid 18 at a second predetermined temperature, when it strikes the vehicle for a predetermined time period defining each wash cycle.

### BRIEF DESCRIPTION OF THE DRAWING

The various features, advantages and other uses of the present invention will become more apparent by referring the following detailed description and drawing in which:

FIG. 1 is a perspective view of a vehicle wash station disposed in a use location;

FIG. 2 is a planned view of the vehicle wash station shown in FIG. 1;

FIG. 3 is a pictorial representation of nozzles mounted in the vehicle wash station shown in FIGS. 1 and 2;

FIGS. 4A, 4B, 4C, and 4D are exploded, perspective views showing the mounting of an oscillating nozzle assembly on the platform of a vehicle wash station;

FIG. 5 is an exploded, perspective view of one of the platform deck module waste fluid collection froth;

FIG. 6 is a partial schematic view of the fluid flow system of the vehicle wash station;

FIG. 7 is a schematic diagram of another portion of the fluid flow control system of the vehicle wash station;

FIG. 8 is a block diagram of the main electrical controls for the vehicle wash station;

FIGS. 9A, 9B, 9C, and 9D depicts side elevational views showing the sequence of movements of a towed vehicle in discrete wash cycle sections over the platform of the wash station;

FIGS. 10A and 10B are flow diagrams depicting the sequence of operation of the control for the vehicle wash station; and

FIG. 11 is a chart showing the wash cycle count for different boat lengths.

### DETAILED DESCRIPTION

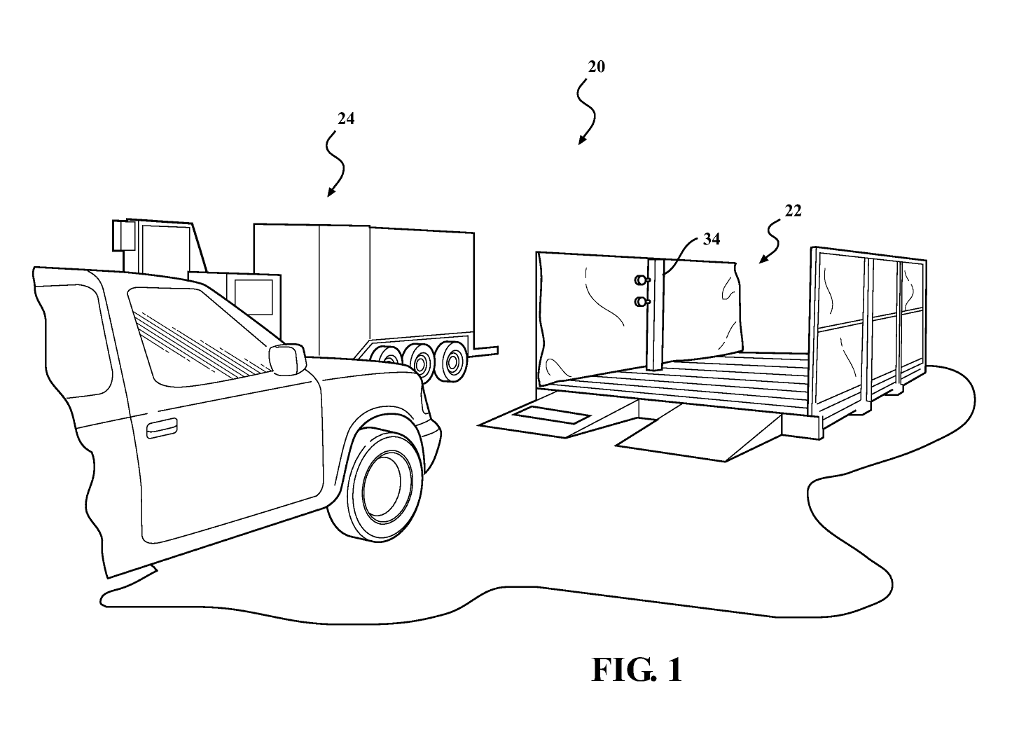

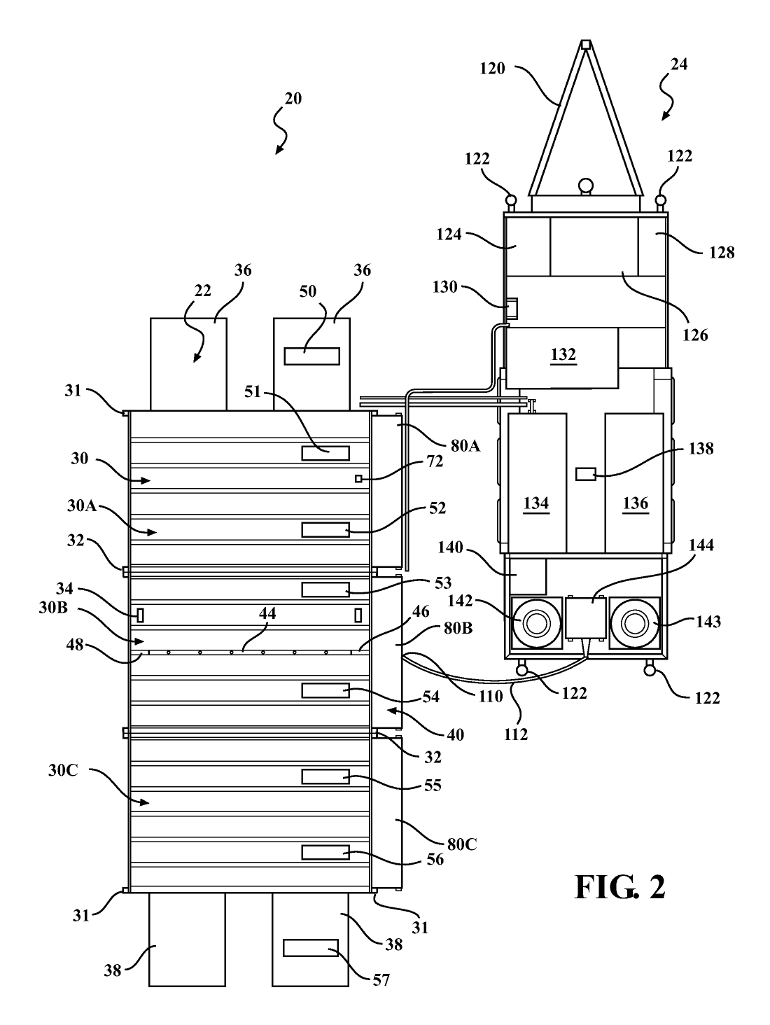

Although the following description of one example of a wash station described in conjunction with FIGS. 1 and 2 perform a wash operation to clean a watercraft and/or a trail for watercraft, it will be understood that the present wash station may also be employed in other applications to clean other vehicles or equipment, such as construction, land management, environmental or agricultural equipment and/or vehicles and towing trailers for such equipment.

One aspect of a self-contained, transportable wash station that can be placed and set-up at use sites, such as water access sites, for example, is shown in FIGS. 1 and 2. The wash station 20 includes a wash platform 22 and a power and control unit 24. The wash platform 22 can be trailered or towed or otherwise delivered to a use site and then moveably or permanently located at the use site.

The power unit 24 is, for example, provided on a separate trailer. The power and control unit 24 is also towed to the use site and, after leveling and set-up, left in place while being electrically and fluidically coupled to the wash platform 22.

As shown in FIGS. 1 and 2, the wash platform 22 includes a deck 30. The deck 30 is designed to support a vehicle and, at the same time, provide a continuous runoff of wash water and debris from the vehicle over the deck 30 to a waste water collection assembly 40. The deck 30 may be formed of a single unitary deck or, as shown by way of example in FIG. 2, a plurality of like deck modules, such as three deck modules 30A, 30B and 30C, may be provided. The deck modules 30A, 30B and 30C are rigidly interconnected by means of suitable connections 32 between adjoining edges of the deck modules 30A, 30B and 30C.

A pair of safety towers 34 is fixed to one deck module 30B and extends vertically between the opposed ends of the deck 30. The safety towers 34 are generally in the form of tubular steel or aluminum members which serve as protection for the adjacent hand wand, flushing ears, and spray nozzles as described hereafter.

A pair of inclined ingress or entrance ramps 36 and a pair of inclined exit ramps 38 are placed, or coupled next to the opposite ends of the deck 30, such as at the free end of the deck module 30A, and the opposed free end of the last arranged deck module 30C.

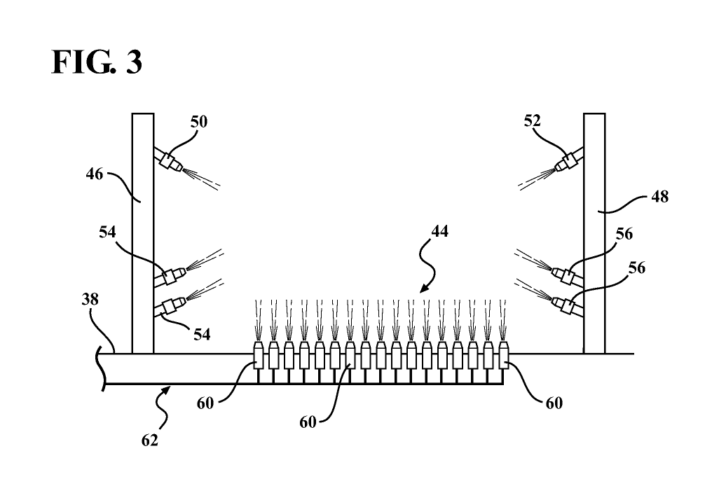

The center located deck module 30B also includes one or more laterally extending banks of oscillating nozzles 44, with one bank of oscillating nozzles 44 shown by way of example in FIGS. 2 and 3.

A pair of spray towers 46 and 48 are laterally spaced apart, generally in-line on opposite sides of the deck module 30B. As shown in greater detail in FIG. 3, the spray towers 46 and 48 support one or more nozzle assemblies 50, 52, 54, 56.

The oscillating nozzles 44 are designed to apply heated wash fluid or wash water to the bottom of the vehicle, such as a boat or other watercraft. The nozzles 54, 56 on the spray towers 46 and 48 are configured and located to wash the upper and lower portions of the hull of a watercraft.

By way of example, four nozzles 50 and 52 are mounted on the upper ends of the spray towers 46 and 48 and are configured for washing the upper portions of a hull of a tall watercraft. The lower mounted nozzle assemblies 54 and 56 include, by example, four spinners, each containing up to four nozzles, for example. The nozzles 54, 56 can be spinner nozzles from Interclean Equipment, Inc., Ann Arbor, Mich.

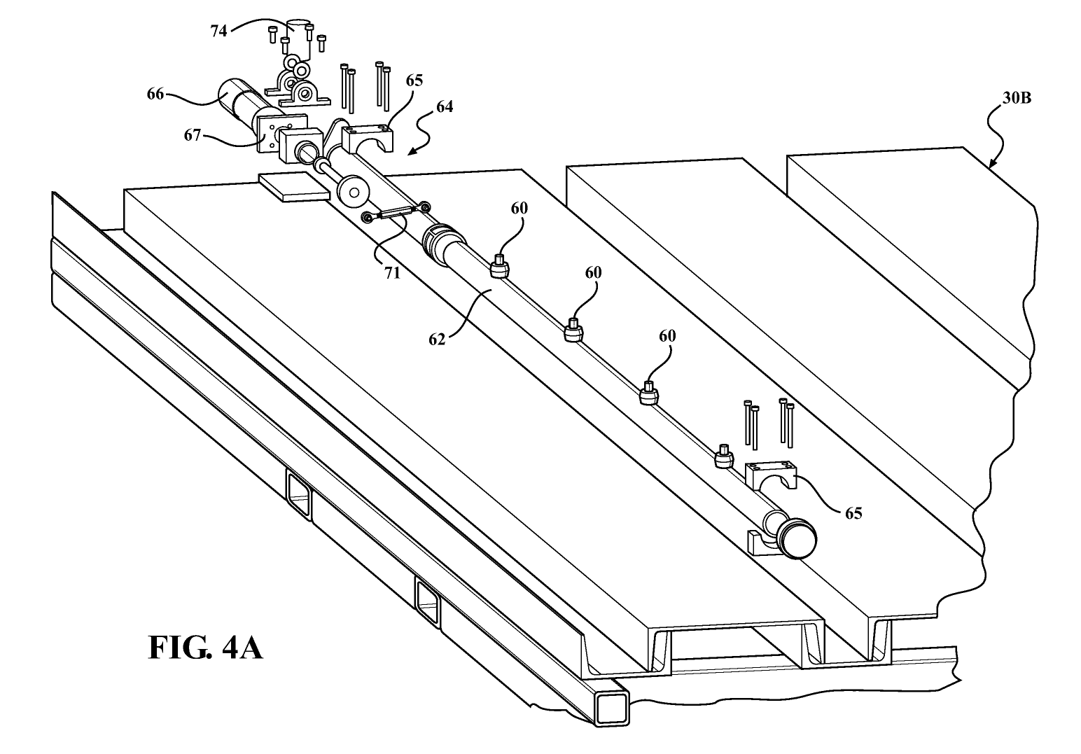

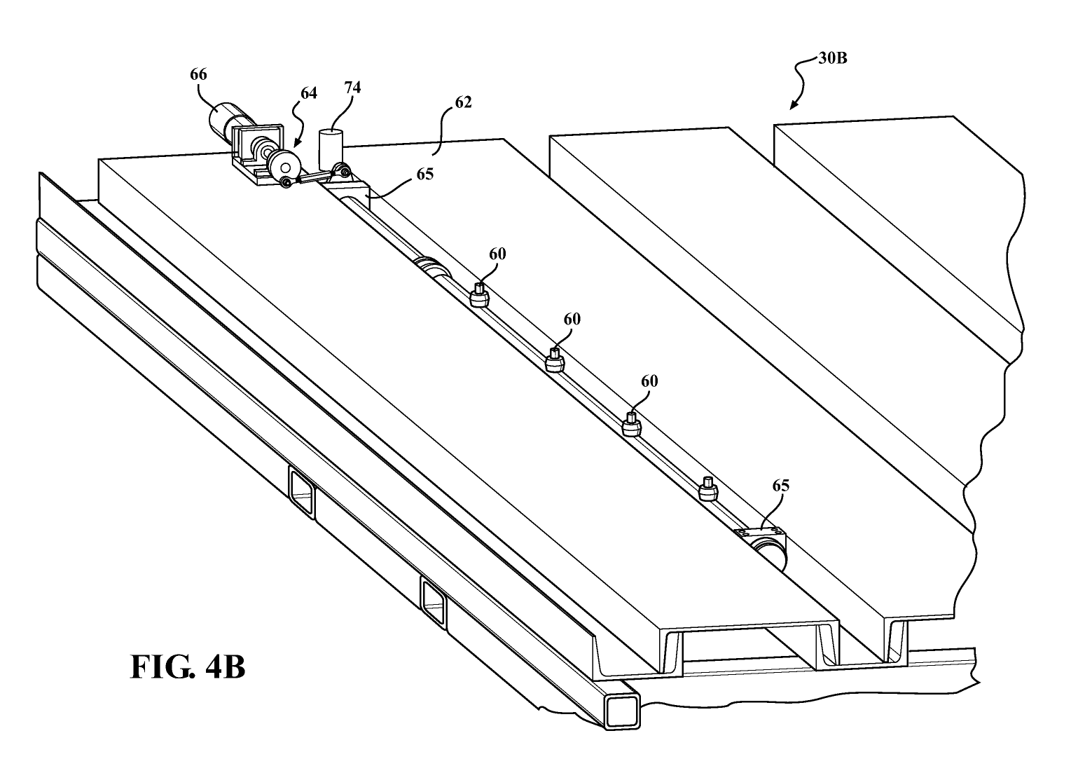

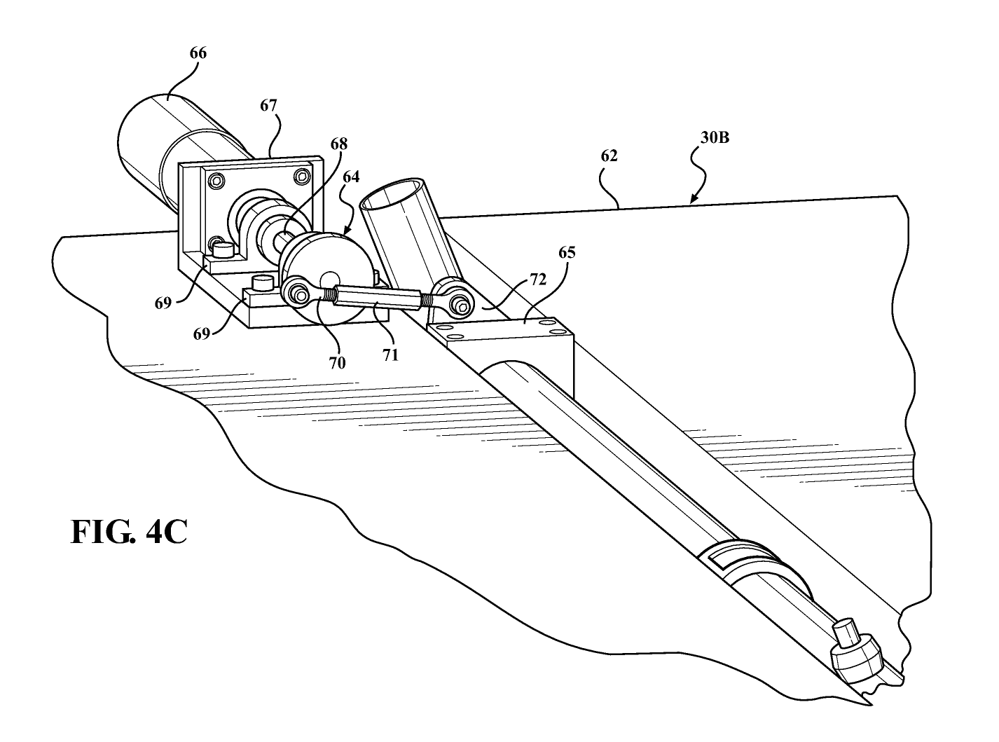

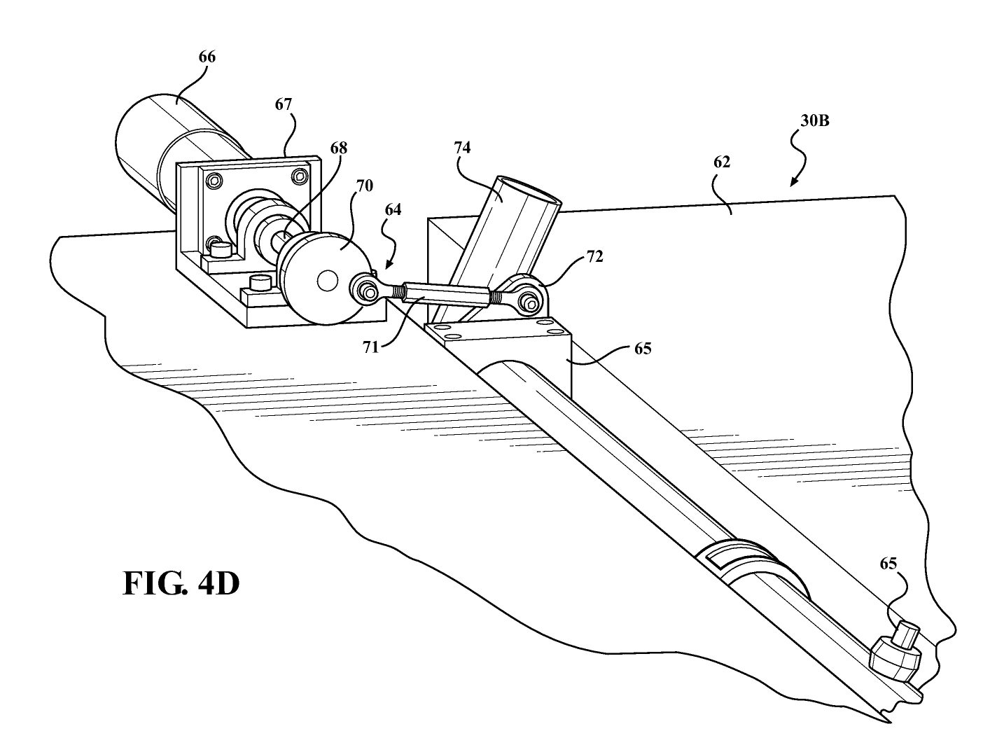

The oscillating nozzles 44 mounted in the platform or on the deck of the center located deck module 30B, as shown in FIGS. 4A-4D includes a plurality of horizontally spaced nozzles 60 which are fluidically coupled to a common water supply manifold 62 as shown in FIG. 4A. The manifold 62, shown in FIGS. 4B-4C and the rigidly interconnected nozzles 60 are oscillated back and forth by a four bar linkage mechanism 64 driven by a motor 66. The four bar linkage 64 convert 360° rotation of a motor 66 output shaft 65 to oscillating back and forth motion over a predetermined angular range of motion of the manifold 62 and the nozzles 60, such as an 80° angular oscillation of the nozzles 60.

As shown in detail in FIGS. 4A-4D, the manifold 62, which is in the form of a tubular, circular cross section pipe, is seated in a pair of spaced journals 65 for rotary movement within one of the valleys in the deck module 30B. The motor 66, which may be a DC motor, is fixedly mounted to the deck module 30B typically along one side edge of the deck module 30B. The output shaft 68 of the motor 66 is rotatably seated within a pair of journals 69 attached to the mounting bracket 67. The end of the output shaft 68 of the motor 66 is fixedly coupled to a rotary disc 70. The rotary disc 70 forms one part of the four-bar linkage mechanism 64 along with an adjustable length link 71 and a flange 72. The link 71 is coupled at opposite ends to the disc 70 and the flange 72. The flange 72 is fixedly coupled, such as by welding, mechanical fasteners, etc., to the manifold 62. As shown in the sequence of operation depicted in FIGS. 4C and 4D, when the motor 66 is energized, the output shaft 68 rotates the disc 70. Rotation of the disc 70 causes one end of the link 71 to also move in a rotary path along with the disc 70. The rotary movement of one end of the link 71 is converted by the link 71 to a back and forth, oscillatory movement of the flange 72 and the attached manifold 62 between extreme angularly spaced positions, such as one position shown in FIG. 4C and an opposed position shown in FIG. 4D. The positions shown in FIGS. 4C and 4D of the flange 72 and the attached manifold 62 define the range of motion and the spray pattern of the nozzles 60 on the manifold 62 as the motor 66 oscillates the manifold 62 back and forth between the extreme angular positions.

A clean water supply tube is coupled to one end of the manifold 62 for supplying clean wash fluid to the manifold 62. The supply tube oscillates with the manifold 62.

The interconnected platform of deck modules 30A, 30B and 30C include jack points 31 at peripheral corners for setting up the unitary platform or deck 30. After bringing the deck 30 to a substantially horizontal, level position, one side edge of the deck 30 is raised slightly above the opposite side edge by a few degrees to allow waste water and debris removed from the vehicle or watercraft to flow laterally across the surface of the deck 30 to the collection assembly 40.

A moveable wash wand 280 and flushing ears 282 are mounted on one of the deck modules, such as deck module 30A. The wash wand 280 allows the user to manually direct wash water over any portion of the watercraft, including both exterior and interior surfaces of the watercraft. The flushing ears 282 are designed to allow the user to manually clean the watercraft outdrive. Through the use of a pressure regulator, the wash wand 280 and the flushing ear water pressure is reduced to garden hose pressure. Before proceeding to temperature sensitive areas, the operator must select “Reduced Temp Decontamination” on a human machine interface (HMI) 130. A controller will activate a mixing valve that reduces and maintains the water temperature at a preprogrammed reduced temperature.

A plurality of pressure sensors S0-S7 are mounted on the deck 30 in a longitudinally spaced manner from one of the entrance ramps 36 to one of the exit ramps 38. Eight sensors S0-S7 are deployed at a predetermined distance apart based on spray patterns along the length of the wash platform 22 and correspond to discrete successive stationary positions of the vehicle along the wash platform 22 and discrete wash cycle positions. In addition, two vertically spaced vehicle/boat present sensors and a tall boat present sensor are mounted on one of the spray towers 46 or 48.

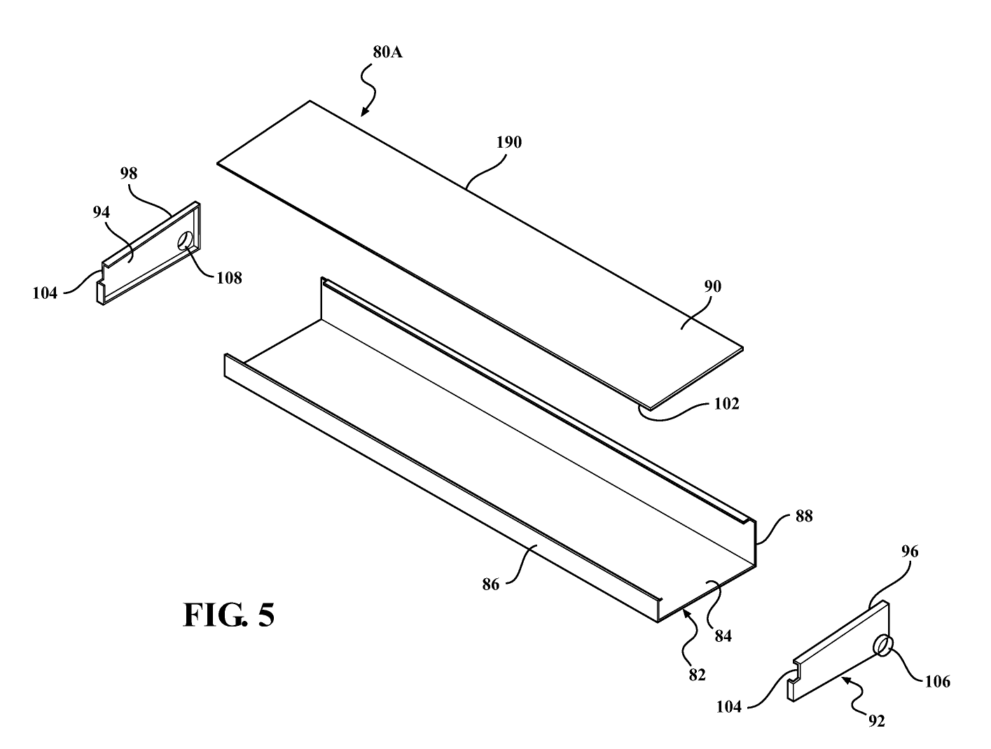

As shown in FIG. 5, the waste water collection assembly 40 includes one collection reservoir or trough 80A, 80B, 80C coupled to each deck module 30A, 30B and 30C, respectively. Each collection trough 80A, 80B, 80C is substantially identically constructed of, as shown in FIG. 5, a lower portion 82, including a bottom wall 84, opposed sidewalls 86 and 88, a top cover plate 90 and opposed end plates 92 and 94. The end plates 92 and 94, as shown in FIG. 5, have an angular upper edge 96 and 98, respectively, which causes the top cover plate 90 mounted thereon to extend at a declining angle from an outer edge 100 to an inner edge 102. The inner edge 102 of the top cover plate 90 is spaced from the sidewall 86 by a notched out portion 104 in the end plates 92 and 94. This creates an opening between the inner edge 102 of the top cover plate 90 and the adjacent edge of the water flow channels in the deck modules 30A, 30B or 30C so that all water flowing across the deck modules 30A, 30B and 30C is received in one of the collection troughs 80A, 80B and 80C.

As also shown in FIG. 5, couplings 106 and 108 are respectively formed on the end plates 92 and 94. The couplings 106 and 108 mate with like couplings 106 and 108 on an adjacent collection trough 80A, 80B or 80C on an adjacent deck module 30A, 30B or 30C to interconnect all of the collection troughs 80A, 80B and 80C into an elongated unitary collection trough in the waste water collection assembly 40. The end couplings 106 and 108 on the outer end located collection troughs 80A and 80C are plugged.

The interconnection of the collection troughs 80A, 80B and 80C into a unitary waste water collection assembly 40 allows a single waste water reclaim connection 110 to be provided on one of the deck modules, such as the center located deck module 30B. The connection 110, which may be a simple screw-on coupling, is connectable by a flexible hose or pipe 112 extending from the collection trough 80B to the dirty wash fluid system on the power and control assembly 24.

As shown in FIG. 2, a plurality of components is mounted on the power and control unit 24. The trailer frame of the power and control unit 24 includes a trailer tow bar 120 and four jack screws 122 located at the outer corners of the of the trailer frame for stabilizing the trailer frame at the use site.

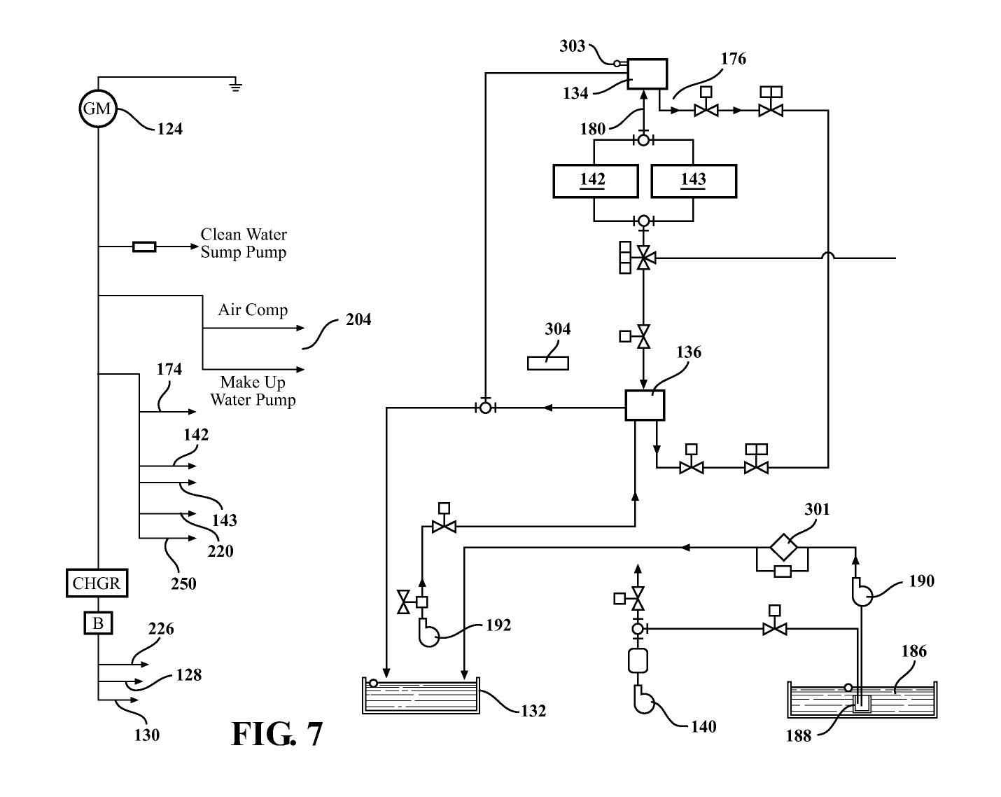

The components mounted on the trailer frame of the portable power and control unit 24, as shown in FIGS. 2 and 7, include a generator/motor 124 which provides electrical power to the system, a fuel tank 126, a control panel 300, a user interface panel 130, and at least one or a plurality, such as three by way of example wash water tanks 132, 134 and 136, a spray pump 178 for directing pressurized clean wash fluid to the wash platform 22, an air compressor 204, at least one, and, for example, two diesel/electric heaters 142, 143, each powered by a diesel motor/generator, and a water reclaim and filter assembly 186.

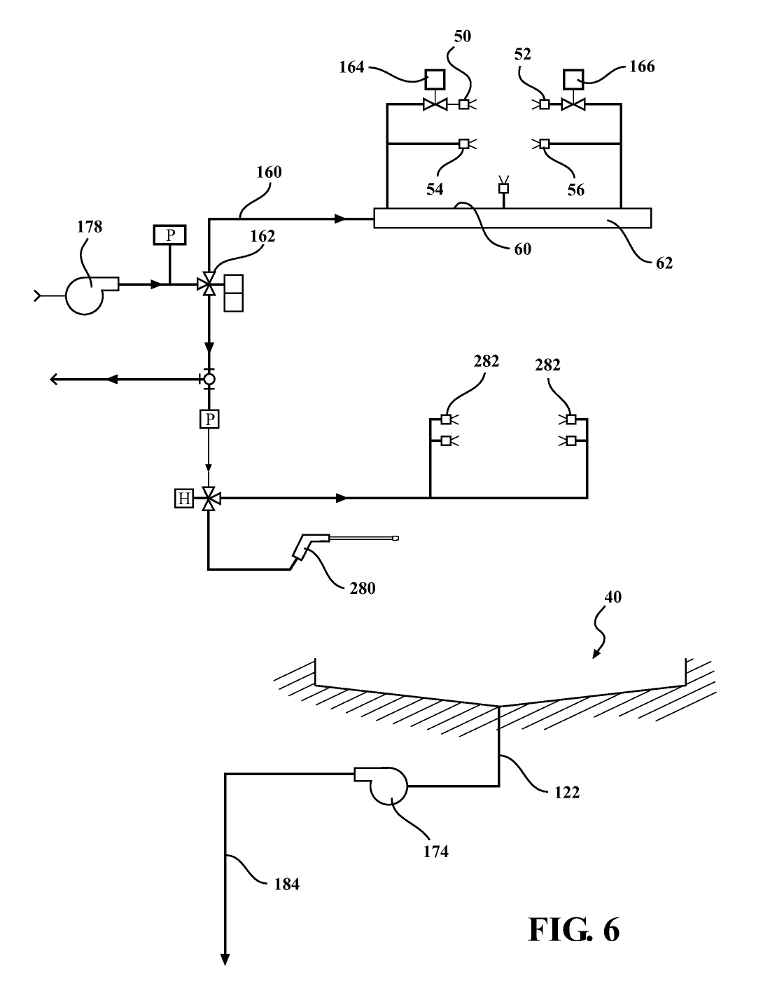

Referring now to FIGS. 6 and 7, there is depicted the fluid and electrical control circuitry and fluid flow pathways used in the wash station 20.

As shown in FIG. 6, the left and right positioned upper nozzles 50 and 52, the left and right lower located spinning nozzles 54 and 56 and the oscillating nozzles 60 coupled to the manifold 62 are supplied with clean water or wash fluid through a first flow conduit 160. Clean wash fluid is supplied from the tank system, as described hereafter, by the control processor or programmable logic controller (PLC) 128 (hereinafter “controller 128”) which controls a solenoid operated, spring return valve 162.

After the automatic clean water application cycles have been completed, the controller 128 switches the valve 162 to a second position to supply clean water to the flushing ears 282 and the hand wand sprayer 280. It will be noted that the upper spray nozzles 50 and 52 are activated by the controller 128 through separate control valves 164 and 166, respectively, when an input is received by the controller 128 from the tall sensor 170 detecting a tall watercraft. The tall watercraft sensor 170 may be any type of sensor, such as a limit switch, proximity detector or, for example, an optical infrared sensor.

Waste water and debris from the cleaning cycle is collected in the waste water collection system 40 and pumped by a pump 174 through a discharge conduit 184.

As shown in FIG. 7, the power and control unit 24 includes a clean water supply control system which is responsive to a preset water application temperature so as to supply clean water at the preset temperature which is intended to facilitate the removal of debris under pressure, and also to be at a preset temperature which is capable of killing live organisms which are attached to the watercraft or vehicle.

At the same time, the clean water supply control system in the power unit 24 is designed so that only the amount of clean water necessary to clean a watercraft of a prescribed length is heated and discharged over the watercraft. By only heating the amount of water that is necessary to clean a watercraft of a prescribed length, energy usage to heat the clean water or wash fluid to the preset temperature is minimized.

As shown in FIG. 7, a source of clean wash fluid includes main or first clean water tank 134 supplies clean water through outlet flow path 176 to the spray pump 178 of the wash platform 22. At least one and, for example, two heaters 142 and 143, are coupled to a conduit 180 to the main tank 134. For example, one or multiple heaters 142, 143 may be diesel fuel powered heaters. One or multiple heaters 142 and 143 may be employed to minimize the amount of time necessary to bring the clean water in the main tank 134 up to the preset temperature to reduce wash cycle times.

Clean water or wash fluid is supplied through one or multiple heater elements 142 and 143 to the main work tank 134 from a second work tank 136. The controller 128 operates flow valves in the flow path between the second tank 136, the spray pump 178, the heater element/elements 142 and 143, and the main tank 134 to replenish the main tank 134 to a working level determined by the controller 128, by example, 350 gallons. Once the working level has been achieved in the main tank 134, the controller 128 will operate flow valves to circulate water from the main tank 134, through the spray pump 178, through the heater/heaters 142 and 143 and back into the main tank 134 to rapidly achieve the preset temperature which can be, for example, 190° F.

Briefly referring again to FIG. 6, as described above, waste water collected in the drain troughs 80A, 80B, 80C is pumped by pump 174 through a conduit 184. The conduit 184 discharges the waste water into a sump 186 contained in the waste water collection system 40 in the power and control unit 24 as shown in FIG. 2. The sump 186 includes a primary filter 188. Primary filtered water is circulated from the sump 186 by a pump 190 through a second filter 301 to the third tank 132 on the power and control unit 24. The water input to the third tank 132 is clean and suitable for reapplication in a subsequent spraying operation over a vehicle or boat. Water is supplied from the third tank 132 via a pump 192 to the second tank 136 which acts as a backup clean water supply for the second tank 136.

Power is supplied to an air compressor 204 which provides pressure for use by the various pneumatic solenoid valves on the power and control unit 24. Power is also supplied to all pumps, the heater/heaters 142 and 143, an FM transmitter 220, and an MP3 audio player as described hereafter.

A battery charger system 222 recharges a 24VDC battery pack 224 for supplying 24VDC power to a controllable relay module (CRM) circuit 226, a processor of the controller 128 and to power the human machine interface (HMI) 130.

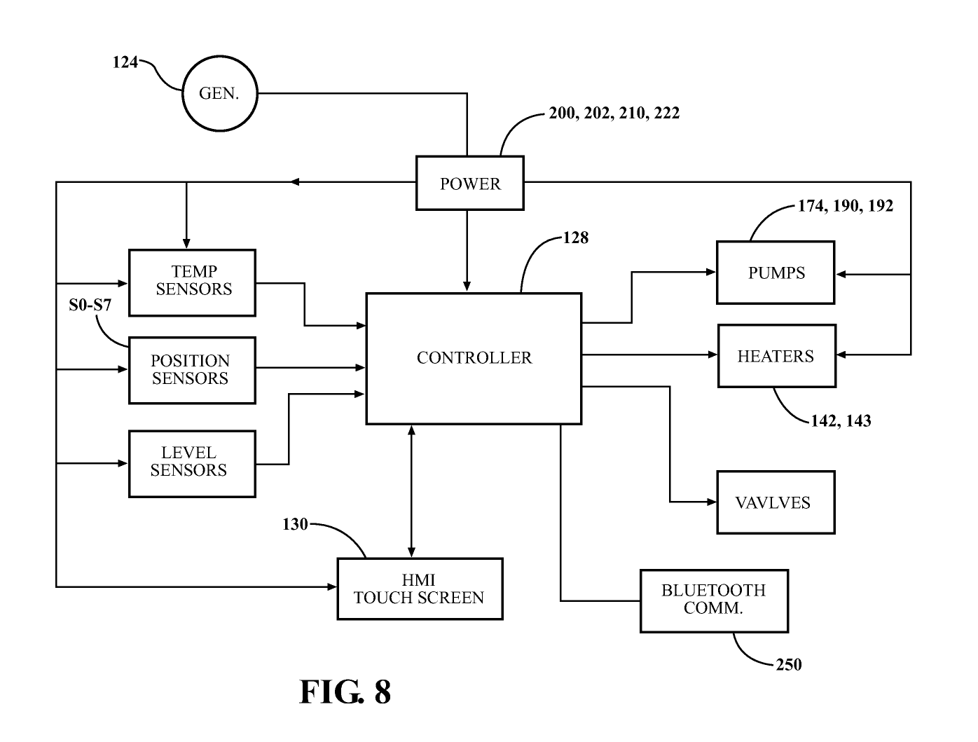

Referring briefly to FIG. 8, there is depicted a block diagram of the electrical control circuit on the power and control unit 24 and the wash platform 22. The controller 128, which may be a microprocessor, a central processor or a programmable logic controller, receives power through the power circuit, including the motor generator set 124. The power circuit also supplies power, as described above to the various other electrically operated components shown in FIGS. 6, 7 and 8.

Inputs to the controller 128 are supplied from temperature sensors associated with the nozzles 50, 52, 54, 56, 60, and the tank temperature sensor 303 on main tank 134. Fluid level sensors associated with the tanks 132, 134 and 136, as well as the sump 186, supply fluid level signals to the controller 128. The human machine interface 130 is also coupled as an input and output to the controller 128.

The controller 128 controls the various pumps 178, 174, 190, and 192, the heaters 142 and 143 and various valves in the fluid circuit, described above and hereafter.

System Operation

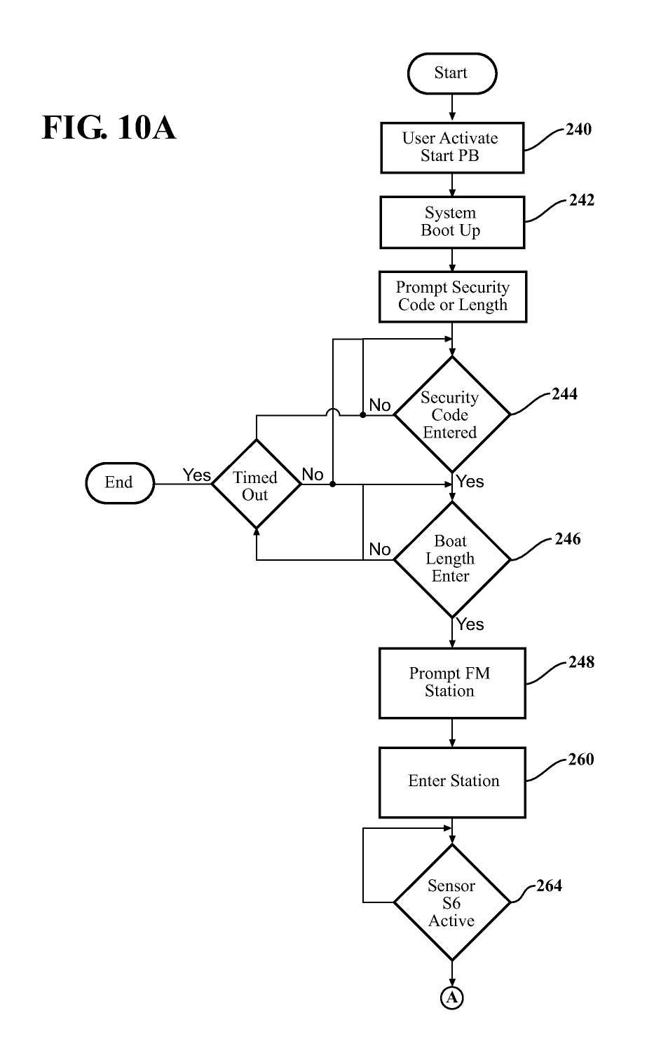

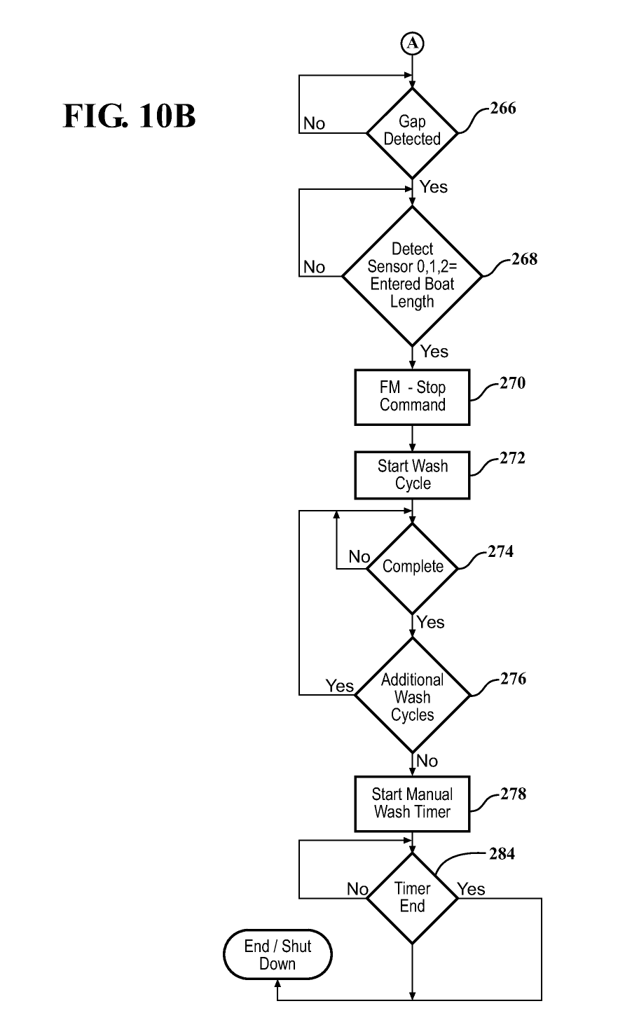

Referring to both FIG. 1 and FIG. 10, when a vehicle approaches the wash station 20, the vehicle owner, or driver (hereafter referred to as the “driver”) will be prompted via signs on the wash station 20 to approach the HMI 130 and press the start button in step 240. A stop button, not shown, is also provided on the control panel 130 to enable the driver to stop the spray sequence of the wash station 20 at any time. During boot-up, the controller 128 checks the status of the tanks 132, 134, 136, and the sensors to determine if all requirements are met to start the systems.

The screen on the HMI 130 will then indicate that the wash system is booting up, as shown in FIG. 10, step 242.

As partially described above, the main tank 134 will be heated to a specified temperature, such as 190° F. based on the ambient temperature. When the water level in the main tank 134 reaches a predetermined low level, as detected by a level sensor 305, the controller 128 automatically replenishes the water level in the main tank 134 from the second tank 136. The controller 128 also causes the third tank 132 to automatically replenish the second tank 136. Water recovered from the wash platform 22 will be filtered and used to refill the third tank 132, as described above.

After the system has booted up and all system operating requirements are satisfied, the controller 128 advances to step 244 where the driver is prompted to enter a security code on the HMI 130 as well as the length of the watercraft or boat 247, including the engine outdrive.

If a valid security code and the boat length are not entered within a prescribed time limit, such as two minutes, for example, the controller 128 resets to look for entry of a new security code.

Once the boat length has been entered in step 246, instructions are given to the driver for further use of the wash station 20. The instructions to the driver can be provided in one or more different formats. For example, pre-recorded voice instructions from a loudspeaker on the wash station 20 can be provided to the driver to control the driver's actions in advancing the watercraft or vehicle through the wash station 20.

Alternately, or in combination with the loudspeaker, lights with printed messages may be mounted on the wash platform 22 to sequentially instruct the driver in moving the vehicle and watercraft through the wash platform 22.

In another communication format, described by way of example, the controller 128 communicates with a communication circuit, such as an FM frequency transmitter circuit 250 shown in FIG. 8. The communication circuit 250 is designed to send signals corresponding to pre-determined voice messages stored in the memory associated with the controller 128 to communicate with the FM radio frequency transmitter capable of reception by the vehicle radio. The HMI 130 will display the FM station that the driver should tune his radio to receive the FM signals. In this way, the driver, while still in the vehicle, will be provided with instructions to sequentially advance, stop and re-advance the vehicle 249 and the watercraft 247 through the wash platform 22 to enable the required number of wash cycles to be completed for the particular length watercraft 247.

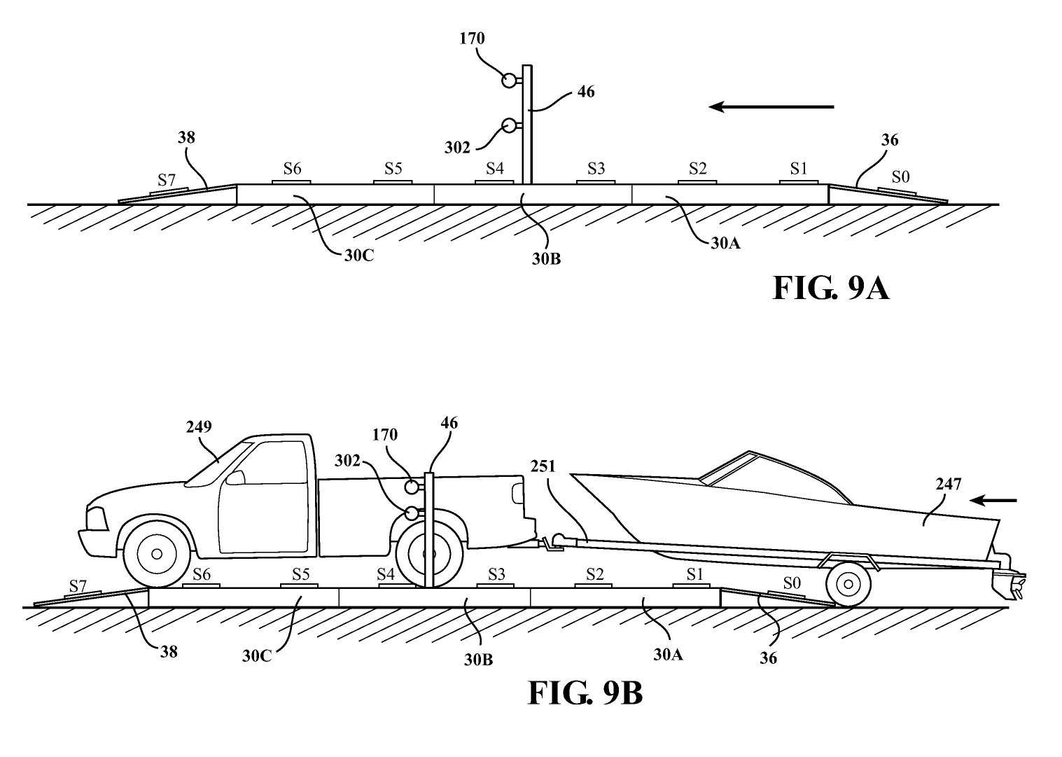

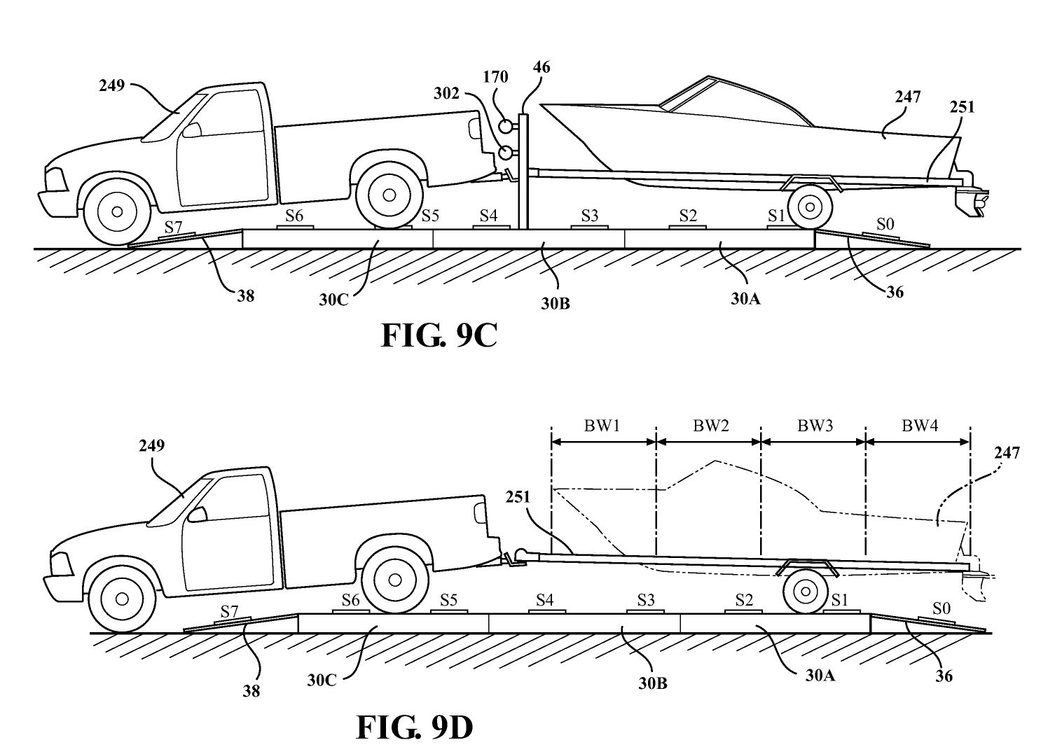

The controller 128 tracks the front axle of the tow vehicle 249 with the wheel sensors S0-S7 mounted on the wash platform deck 30 and the front and rear of the tow vehicle 249 using the vehicle/watercraft present tall watercraft sensor 302 on the spray tower 46, as shown in FIG. 9A. The sensor 302 may be identical to the sensor 170, that is, an optical infrared sensor. Alternately, limit switches, proximity switches, etc., may also be employed for the sensor 302.

As the driver continues to advance the tow vehicle 249 through the wash platform 22, the controller 128 looks for activation of sensor S6 in Step 264 to detect the front axle of the tow vehicle 249, as shown in FIG. 9B.

If the sensor S5 is then activated by a wheel of the tow vehicle 249 before sensor S4 is activated, the controller 128 determines that the vehicle is backing up. The controller 128 sets the tow vehicle front axle detection to an undetected state and waits again for sensor S6 to be activated.

Once the front axle of tow vehicle 249 has been detected by sensor S6, the controller 128 waits for activation of the vehicle/watercraft present sensor 302 by the rear wheel of the tow vehicle 249 to go to an undetected or non-present state which establishes a gap between the tow vehicle 249 and the front edge of the watercraft trailer 251, as shown in FIG. 9C.

If the vehicle/boat presence sensor 302 returns to a detected state and sensor S4 is detected, the controller 128 assumes that the vehicle is backing up. The gap state is reset to a “not found” state. The controller 128 again waits for an undetected gap state.

When the tow vehicle 249 to trailer 251 gap is found, that is, the vehicle/watercraft present sensor 302 changes to a detected state detecting the front edge of the trailer 251 of the watercraft 247, the controller 128 looks for activation of either wheel pressure sensors S0, S1, S2 or S3, depending upon the boat length previously entered by the driver. When one of these sensors S0-S3 is detected, the controller 128, via the FM transmitter circuit 250, instructs the driver to stop further movement of the vehicle 249. The controller 128 then initiates the automatic wash cycle in step 272.

One feature of the wash station 20, as shown in FIG. 9D, is that the duration of each wash cycle is determined by the water temperature of the wash fluid discharged from the nozzles 50, 52, 54, 56 and 60 satisfying a predetermined set point temperature for a specific amount of time. This is to insure that all bacteria or organisms which may have attached themselves to the boat hull or outdrive have been killed.

The completion of the wash cycle in step 274 is determined by the controller 128 monitoring the temperature at the various nozzles and the spray time of fluid flow through the nozzles. Once the temperature set point has been achieved for the specified amount of time, the controller 128, through the FM communication system, will prompt the driver to move the vehicle 249 forward and stop at the next wash cycle distance. This advance and stop sequence is repeated by the controller 128 and relayed via the FM transmitter circuit 250 to the driver until all of the wash cycles corresponding to the length of the watercraft 247 have been completed. Thus, the controller 128 determines if additional wash cycles are required in step 276 for the entered watercraft length. Steps 272, 274 and 276 are repeated until the entire length of the watercraft 247, as entered by the driver, has been subjected to a spray operation.

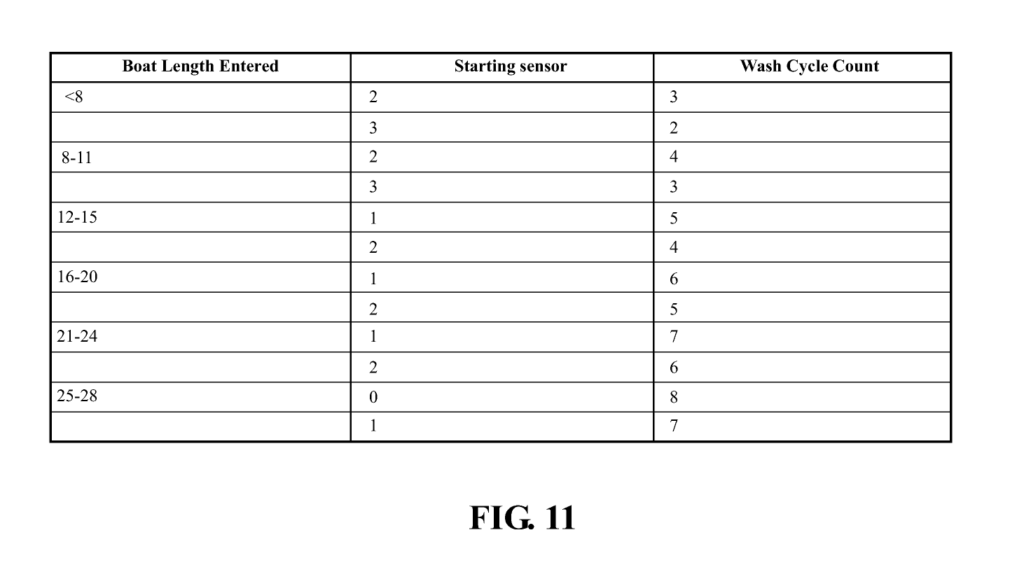

FIG. 11 is a chart illustrating examples of the number of wash cycles for different boat lengths, FIG. 9D illustrates a feature in which the watercraft length, including the outdrive, as entered by the driver through the HMI 130, is used by the controller 128, executing an algorithm in a memory stored control program, to divide boat length into approximately equal length sections which correspond to the overall length of the spray pattern or band width of the nozzles 50, 52, 54, 56 and 60.

By way of example, for a watercraft length of 8 to 11 feet, as shown in FIGS. 9D and 11, four bandwidths BW1, BW2, BW3 and BW4 are provided for the watercraft 247.

After the front edge of the watercraft is detected by the sensor 302, the controller 128 will issue a command via the FM communication system 250 through the vehicle radio to tell the driver to immediately stop the vehicle which will assume the position shown in FIG. 9D, for example. In this position, the nozzles 50, 52, 54, 56 and 60 are substantially centered in the first section or bandwidth BW1 of water spraying over the exterior of the boat 247. As stated above, steps 272, 274 and 276 are repeated and instructions given to the driver of the vehicle to advance and stop the vehicle 249 and watercraft 247 in each successive section or bandwidth BW2, BW3, and BW4 so that all exterior portions of the hull of the watercraft 247, including the outdrive, are sprayed with wash fluid or water.

In addition to the spray patterns of the nozzles for each section of the watercraft 247, to ensure that substantially the entire exterior surface of the watercraft 247 receives heated wash fluid, the temperature of the wash fluid at each nozzle 52, 54, 56, and 60 is monitored by the controller 128 via temperature sensors coupled to each nozzle 52, 54, 56 and 60. This enables the controller 128 to uniquely provide a predetermined quantity of wash fluid at a second preset discharge temperature for the duration of predetermined discharge time period of a wash cycle to ensure that substantially all organisms and bacteria that may have adhered to the hull of the watercraft 247 are killed. The pressure of the wash fluid sprayed on to the watercraft 247 will also assist in removing such organisms and bacteria from the hull of the watercraft 247.

In the above example, the wash fluid in the main tank 134 can be heated to a first predetermined temperature, such as 190°. Heat loss occurring between the time when the water leaves the nozzles 50, 52, 54, 56, and 60 and when it comes into contact with the hull is affected by the ambient temperature, with higher heat loss occurring at lower ambient temperatures and less heat loss at higher ambient temperatures. Thus, the higher temperature of the wash fluid discharged through the nozzles insures that the water will be at a second preset, slightly lower temperature, such as 165 degrees F., when it contacts the hull. The second preset temperature is selected so that it is sufficient to kill substantially all organisms adhering to the boat hull when a sufficient quantity of water is sprayed on to the exterior of the boat hull during the total time period of each wash cycle.

The controller 128 adjusts the first temperature of the water in the main tank 134 higher or lower dependent on the ambient temperature to insure that the water is at the second preset temperature when it contacts the hull at higher ambient temperature. Thus, for higher ambient temperatures, the controller 128 will decrease the temperature of the wash fluid at the point of discharge from the nozzles by lowering the temperature of the wash fluid in the main tank 134. Thus, fewer cycles of the wash fluid through the heater/heaters 142, 143 may be necessary due to the lower temperature of the wash fluid thereby saving fuel and energy to power the heaters 142, 143.

In lower ambient temperatures, more heat will be lost from the time the wash fluid is discharged from the nozzles to the time that the wash fluid contacts the hull of the watercraft. In this situation, the controller 128 will increase the temperature of the wash fluid in the main tank 134 to a higher first temperature, such as above 195° F., so that the temperature of the wash fluid when it contacts the hull of the water craft is at the second predetermined temperature 247 necessary to kill substantially all organisms and bacteria which may be present on the hull of the water craft.

When all of the programmed wash cycles shown in FIG. 11 for the particular length watercraft 247 entered by the driver have been completed, the controller 128 advances from step 276 to step 278. In step 278, the controller 128 will instruct the driver via the FM transmitter circuit 250 to leave the vehicle in the last wash cycle position on the deck 30 and exit the vehicle to use the wand 280 and the flushing ears 282 to clear out the live wells and other water reservoirs on the watercraft 247. The controller 128 starts a timer in step 284 providing a predetermined time for the manual wash, such as five minutes. After the preprogrammed amount of time expires, the spray pump 178 to the wand 280 and the flushing ears 282 is turned off. When one minute remains in the manual wash cycle, the controller 128 activates an audible alarm for ten seconds. The user has the option to request additional time for the decontamination via the touch screen in the HMI 130.

At the completion of the manual wash cycle, either automatically spray at the expiration of the present time period in step 284 or when the driver turns off the wand 280 and the flushing ears 282, the driver will reenter the tow vehicle 249 and exit the wash station 20.

In addition to the automatic mode of operation described above and shown in FIG. 10, the control system also has configurable system parameters as well as a manual mode of operation. These additional features are helpful when servicing or troubleshooting the wash station 20.

To access these features, a user touches the upper left corner of the boat length screen on the HMI 130. The user will then be prompted for a user name and password.

Upon entering these items, a “config” button will appear on the lower left corner of the boat length screen on the HMI 130. Pressing the “config” button will display a new screen with a series of configuration options allowing access to system status and system parameters. Selecting any option from the configuration option screen will display a new screen of options. The user may navigate to any one of the automatic screens by selecting from the options presented on the configuration options screen.

Selecting “system parameters” allows parameters of the automatic mode to be edited or revised. For example, the following parameters can be changed:

1. The main tank 134 water temperature for the wash cycle—default is 190° F.

2. Nozzle discharge temperature for the wash cycle—default is 165° F.

3. Wash cycle duration—default is twenty seconds.

4. FM radio frequency.

5. Manual mode.

When in the manual mode, the automatic system is disabled and the user has the ability to manually cycle the wash system valves and pumps.

What is claimed is:

1. A method of washing a vehicle comprising:
determining an amount of clean wash fluid to wash the complete exterior of the vehicle; and
heating only the determined amount of clean wash fluid to wash the complete exterior of the vehicle.

2. The method of claim 1 wherein the step of heating comprises:
heating the determined amount of clean wash fluid to a first predetermined temperature so that the temperature of the clean wash fluid discharged from at least one nozzle onto the vehicle is at a second predetermined temperature.

3. The method of claim 1 further comprising:
providing an overall length of the vehicle to be washed;
providing a quantity of clean wash fluid in a first tank sufficient to completely wash the exterior of the predetermined length vehicle; and
heating the quantity of clean wash fluid in the first tank to a first predetermined temperature so that the temperature of the clean wash fluid discharged from at least one nozzle is at a second minimum predetermined temperature.

4. The method of claim 4 further comprising:
supplying the first tank with the predetermined quantity of clean wash fluid.

5. The method of claim 4 further comprising:
providing a waste water fluid collection reservoir;
providing a filter disposed in fluid flow communication with the waste water collection reservoir for filtering the dirty wash fluid of contaminants to create clean wash fluid; and
disposing a clean wash fluid reservoir in fluid flow communication between the filter and the first tank.

6. The method of claim 5 further comprising:
disposing a refill tank disposed in fluid flow communication between the clean wash fluid reservoir and the first tank; and
providing fluid flow means for transferring clean wash fluid from the clean wash fluid reservoir to the refill tank.

7. The method of claim 1 further comprising:
defining a plurality of consecutive wash cycles, each of a predetermined time period, and each corresponding to a portion of the determined length of the washed vehicle
discharging clean wash fluid at a second predetermined temperature during each of the plurality of wash cycles; and
advancing the vehicle through the wash station with respect to the plurality of nozzles between each wash cycle.

8. A wash apparatus comprising:
a platform with opposed ends for supporting a vehicle during a wash operation as the vehicle advances from end to end of the platform;
at least one nozzle mounted on the platform;
a supply of clean wash fluid;
at least one heater for heating a quantity of clean wash fluid to a first predetermined temperature; and
a control for discharging the heated clean wash fluid through the at least one nozzle at a second predetermined discharge temperature over a predetermined discharge time period.

9. The wash apparatus of claim 8 wherein:
the at least one nozzle mounted on the platform for oscillatory movement to spray clean wash fluid over a predetermined bandwidth of the vehicle.

10. The wash apparatus of claim 9 wherein the at least one nozzle comprises:
a plurality of nozzles mounted on the platform for oscillatory movement about an axis.

11. The wash apparatus of claim 8 wherein the at least one nozzle comprises:
at least one nozzle mounted on the platform for rotary spinning movement to spray clean wash fluid over a predetermined bandwidth of the vehicle.

12. The wash apparatus of claim 11 wherein the at least one nozzle comprises:
a plurality of nozzles, each configured for rotary spinning movement about an axis.

13. A wash apparatus comprising:
a platform with opposed ends, the platform supporting a vehicle during a wash operation as the vehicle advances from end to end on the platform;
a plurality of discrete, stationary, spaced vehicle positions on the platform, each discrete stationary vehicle position defining a discrete wash cycle position; and
at least one nozzle configured for discharging clean wash fluid onto successive bandwidth sections of the vehicle defined by a successive and stop advance of the vehicle between each discrete stationary vehicle position on the platform.

14. The wash apparatus of claim 13 further comprising:
a plurality discrete position sensors carried on the platform, each sensor defining one of the plurality of discrete stationary spaced vehicle positions on the platform for a discrete wash cycle application of clean wash fluid onto the vehicle.

15. The wash station of claim 13 further comprising:
during each bandwidth application of clean wash fluid onto the vehicle, at least one nozzle discharging clean wash fluid is discharged at a second predetermined temperature for a predetermined time period defining each wash cycle.

16. A method of washing a vehicle exposed to a body of water comprising:
heating a wash fluid to a predetermined temperature such that the temperature of the wash fluid when the wash fluid contacts an exterior surface of the a vehicle exposed to a body of water after the wash fluid is discharged from a nozzle is sufficient to kill all organisms adhered to the vehicle.

17. The method of claim 16 further comprising:
discharging the heated wash fluid onto the vehicle at the temperature for a predetermined time sufficient to kill all of the organisms that may be attached to the vehicle.

18. The method of claim 17 further comprising:
providing a platform for receiving a vehicle in a washing operation;
mounting a plurality of nozzles on the platform to cover a predetermined bandwidth of water discharge area;
discharging heated wash fluid from the plurality of nozzles successively onto each of a plurality of adjacent sections of the vehicle, where the sections correspond to successive bandwidth discharge areas of the plurality of nozzles.

19. The method of claim 18 further comprising:
providing a plurality of distinct positions of the vehicle on the platform with respect to the plurality of nozzles such that each adjacent section of the vehicle is consecutively disposed within the bandwidth discharge area of the plurality of nozzles.

20. The method of claim 16 further comprising:
heating the quantity of wash fluid to a first predetermined temperature so that the temperature of the wash fluid applied to the vehicle is at the predetermined temperatures sufficient to kill organisms adhered to the vehicle.

21. The method of claim 20 further comprising:
determining an amount of wash fluid to wash a complete exterior of the vehicle; and
heating only the determined amount of wash fluid to wash the exterior of the vehicle to the first predetermined temperature.

22. The method of claim 1 further comprising:
heating only the determined amount of wash fluid to a predetermined temperature such that the temperature of the washed fluid when the wash fluid contacts an exterior surface of the a vehicle exposed to a body of water is sufficient to kill organisms adhered to the vehicle.

23. A method of washing a vehicle exposed to organisms in the body of water comprising:
providing a platform for supporting a vehicle during a wash operation as the vehicle advances from end to end on the platform;
providing a plurality of wash fluid discharge nozzles over a bandwidth area of fluid discharge; and
advancing the vehicle along the platform in discrete incremental distances so that each of a plurality of adjacent, substantially equidistant sections of the vehicle, which sections correspond to the bandwidth area of discharge of a plurality of nozzles, are disposed within the bandwidth area of discharge of the nozzles.

24. The method of claim 23 further comprising:
providing a length of the vehicle;
dividing, by a control executing a stored program, the provided vehicle length into a plurality of substantially equal lengths sections on the vehicle;
providing at least one sensor on the platform for detecting the incremental advance of the vehicle over the platform to bring each section of the vehicle into the bandwidth area of discharge of the plurality of nozzles.

25. The method of claim 23 further comprising:
for each section of the vehicle, discharging wash fluid from the plurality of nozzles at a predetermined temperature and for a predetermined total time of discharge sufficient to fill organisms attached to the vehicle.
